(19) United States
(12) Patent Application Publication
(10) Pub. No.: US 2006/0221258 A1
(43) Pub. Date: Oct. 5, 2006

(54) Projection TV

(75) Inventors: Jong-Soo Lee, Cheonan-si (KR); Kun-Ho Cho, Suwon-si (KR); Kirill Sokolov, Suwon-si (KR); Borodouline Alexei, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/300,460

(22) Filed: Dec. 15, 2005

(30) Foreign Application Priority Data
Mar. 30, 2005 (KR) 2005-26499

(51) Int. Cl. H04N 9/31; H04N 5/74

(52) U.S. Cl. 348/744; 348/771

(57) ABSTRACT

Provided is a projection television TV having a digital micro mirror device (DMD) which includes micro-mirrors to reflect light from a light source according to an ‘on’ or ‘off’ state of the micro mirrors. An illuminating block provides light to the DMD in a uniform optical intensity. A projecting block projects the light reflected from the DMD onto a screen. The projection TV features a projection aperture positioned in the projecting block or the illuminating block arranged perpendicularly to an optical axis. The projection aperture forms an optical path and includes projection areas to pass the light and blocking areas to block the light. The projection area and the blocking area are formed on a cross section of the light with a predetermined space.

### CROSS-REFERENCE TO RELATED APPLICATIONS

This application claims the benefit under 35 U.S.C. § 119(a) of Korean Patent Application No. 2005-26499, filed Mar. 30, 2005, in the Korean Intellectual Property Office, the entire disclosure of which is hereby incorporated by reference.

### BACKGROUND OF THE INVENTION

1. Field of the Invention

The present invention relates to a projection television (TV). More particularly, the present invention relates to a projection TV which improves image clearness and contrast by removing diffracted light and scattered reflection light included in light from a light source.

2. Description of the Related Art

Generally, a projection television (TV) embodies an image on a large screen by forming an image in an image forming device such as a cathode ray tube (CRT) and a liquid crystal display (LCD). The projection TV projects the image onto a large screen through an illuminating block, a projecting block, and a reflection mirror.

FIG. 1 is a schematic view showing an illuminating block and a projecting block of a projection TV. The projection TV includes the illuminating block, the projecting block, and a digital micro-mirror device (DMD) 30 to project an image. The illuminating block 5 includes an illuminating lamp 7, an elliptical reflector 10, an optical tunnel 15, relay lenses 20, and a reflection plate 35.

The illuminating block 5 provides light of a uniform intensity to the projecting block 40. Light radiated from the illuminating lamp 7 is reflected by the elliptical reflector 10. Then, the light is converged and provided to the optical tunnel 15.

The optical tunnel 15, which is formed in the shape of a hollow rectangular barrel having a rectangular cross section, reflects the light from the elliptical reflector 10 while the light passes through the inside of the optical tunnel 15. Herein, since the horizontal and vertical widths of the optical tunnel 15 are different, the intensity of reflection light reflected off the inner walls of the optical tunnel 15 is uniform while the light passes through the optical tunnel 15. Accordingly, light is radiated from a plurality of light sources.

The relay lenses 20 are a pair of lenses, for example a first lens and a second lens, spaced apart a predetermined distance from each other. The relay lenses 20 converge light radiated while the light passes through the optical tunnel 15. Herein, as shown in FIG. 2, the light that has passes through the first lens forms a plurality of light convergence points with a predetermined space in the horizontal and vertical directions within a predetermined range.

The reflection plate 35 provides the light from the relay lenses 20 to the projecting block 40. A reflection mirror or a Total Internal Reflection (TIR) prism can be used as the reflection plate 35.

Meanwhile, the DMD 30 is a reflective Micro Electro Mechanical Systems (MEMS) device. A plurality of micro mirrors are arranged on a reflection surface of the DMD 30 in the form of a plane. The micro mirrors rotate to an incidence angle such as +10 to +12 or −10 to −12 with respect to the reflection surface of the DMD 30. The number of micro mirrors correspond to the number of screen pixels. Each micro mirror is spaced apart a predetermined space from an adjacent micro mirror. If light is incident on the micro mirrors, scattered reflection occurs in the border areas of each micro mirror or a diffraction phenomenon occurs by the cracks between the micro mirrors. Thus, the diffracted lights and scattered reflection light are included in the light inputted to projecting lenses. Therefore, since the light normally reflected by the micro mirrors includes the diffraction light and the scattered reflection light, the image quality may degrade.

The projecting block 40 includes a front lens group 45 and a rear lens group 55 to receive the luminous flux reflected in the DMD 30. The projecting block 40 forms an image on the screen by enlarging the luminous flux interrupted by the DMD 30. Herein, the front lens group 45, which is formed of a plurality of lenses, converges the luminous flux from the DMD 30. The rear lens group 55, which also includes a plurality of lenses, diffuses the luminous flux to reach the screen.

A projection aperture 50 having a penetrating projection opening in the center is provided between the front lens group 45 and the rear lens group 55. The luminous flux converged by the front lens group 45 passes through the projection opening and is provided to the rear lens group 55. The luminous flux that passes through the projection opening of the projection aperture 50, as illustrated in FIG. 3, forms a plurality of light convergence points with a predetermined space between them just as the luminous flux forms light convergence points between the relay lenses 20. Herein, the formed light convergence points are arranged at 90° with respect to the arrangement of the light convergence points of the relay lenses 20. The projection aperture 50 prevents the clearness of the image formed on the screen from degrading due to unnecessary light, by blocking the light that goes out of a predetermined rage of the luminous flux converged in the front lens group 45.

When the light is reflected in the DMD 30, if the micro mirrors are in the “off” state to reflect the light from the micro mirrors to the outside, as illustrated in FIG. 4, the micro mirrors are set at a predetermined degree, for instance, at a degree of about −10 to −12. Since the micro mirrors in the “off” state are all arranged to slant to the same direction, the light reflected from the micro mirrors in the “off” state are reflected toward one direction with respect to the lenses of the front lens group 45. Therefore, naturally, diffraction or scattered reflection of the light are mainly caused in one direction with respect to each lens.

To prevent the unnecessary light generated by the diffraction and the scattered reflection from being formed into an image, several methods are suggested to block the area where the diffraction or the scattered reflection mainly occurs. U.S. Pat. No. 6,724,546, the entire disclosure of which is hereby incorporated by reference, discloses a method where one area of a projection opening through which the diffracted light or scattered reflection light passes is formed narrowly. The area of the projection opening blocks diffracted light or scattered reflection light included in the light passing through the projection opening of the projection aperture 50. U.S. Patent Publication No. 2003/0206328, the entire disclosure of which is hereby incorporated by reference, discloses a technology which blocks diffracted light or scattered reflection light by forming the slot of an aperture in the form of an iris to control the entire size of the slot. However, although the conventional methods for controlling the size of the slot or the projection opening can block the diffracted light and the scattered reflection light generated in the border area of light, there is a problem that it is relatively difficult to block out all the diffracted light or scattered reflection light generally existing in the luminous flux.

Therefore a need exists for the development of a method for blocking the diffracted light or scattered reflection light entering through the areas between the light convergence points, when the luminous flux is converged by the relay lenses 20 of the illuminating block 5 and the projection lenses of the projecting block 40, to remove the diffracted light or the scattered reflection light which generally exists in the luminous flux to improve the image contrast.

Accordingly, there is a need for an improved projection television (TV) which removes diffracted light or scattered reflection light to improve image contrast.

### SUMMARY OF THE INVENTION

An aspect of the present invention is to solve at least the above problems and/or disadvantages and to provide at least the advantages described below. Accordingly, an aspect of the present invention is to provide a projection television (TV) which improves image contrast by removing diffracted light or scattered reflection light generally existing in luminous flux.

In order to achieve the above identified object, an aspect of the present invention is to provide a projection television (TV) comprising a digital micro-mirror device (DMD) including a plurality of micro mirrors which reflect the light from a light source according to an ‘on’ or ‘off’ state of the micro mirrors. An illuminating block provides the light to the DMD in a uniform optical intensity by controlling the light from an illuminating lamp as the light source. A projecting block projects the light reflected from the DMD onto a screen. A projection aperture is arranged on an optical path of the projecting block or the illuminating block on a plane vertical to an optical axis of the optical path. The projection aperture includes projection areas formed at a predetermined distance from the cross section of the light source and passes light from the light source. The projection aperture also includes blocking areas to block the light.

The projecting block may include a front lens group which converges the light from the DMD. A rear lens group diffuses and projects the light from the front lens group onto the screen. The projection aperture is positioned between the front lens group and the rear lens group.

Preferably, a plurality of light convergence points are formed between the front lens group and the rear lens group from the light converged by the front lens group in four directions with predetermined spacing. The projection areas of the projection aperture are formed to correspond to the light convergence points.

The illuminating block may also include an optical tunnel which makes the light from the light source have a uniform optical intensity and a plurality of relay lenses to converge the light outputted from the optical tunnel. The projection aperture is placed in any one position between the relay lenses.

Preferably, a plurality of light convergence points are formed between the relay lenses from the converged light in four directions with a predetermined space therebetween, and the projection areas of the projection aperture are formed to correspond to the light convergence points between the relay lenses.

The projection areas of the projection aperture may also be arranged in one direction of the projection aperture with a predetermined space. A plurality of penetrating projection slots are formed longitudinally in the other direction of the projection aperture while the blocking areas are formed in a shape of a long blocking bar in the longitudinal direction of the projection slots and positioned between the projection slots.

The projection areas corresponding to the light convergence points may be formed in a shape of a projection opening penetrating the projection aperture. The blocking areas are formed to be an area except the projection openings.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a schematic view showing an illuminating block and a projecting block of a projection television (TV);

FIG. 2 illustrates an optical distribution of light from a light source between the relay lenses in the illuminating block of FIG. 1;

FIG. 3 illustrates an optical distribution of light from a light source between a front lens group and a rear lens group in the projecting block of FIG. 1;

FIG. 4 is a cross-sectional view illustrating micro mirrors that are in the “off” state in a digital micro-mirror device (DMD) of FIG. 1;

FIG. 5A is a plane view illustrating a projection aperture in accordance with a first embodiment of the present invention;

FIG. 5B is a plane view illustrating the projection aperture of FIG. 5A mounted on a projecting block;

FIG. 6A is a plane view showing a projection aperture in accordance with a second embodiment of the present invention; and

FIG. 6B is a plane view describing the projection aperture of FIG. 6A mounted on a projecting block.

Throughout the drawings, the same drawing reference numerals will be understood to refer to the same elements, features, and structures.

### DETAILED DESCRIPTION EXEMPLARY EMBODIMENTS

The matters defined in the description such as a detailed construction and elements are provided to assist in a comprehensive understanding of the exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

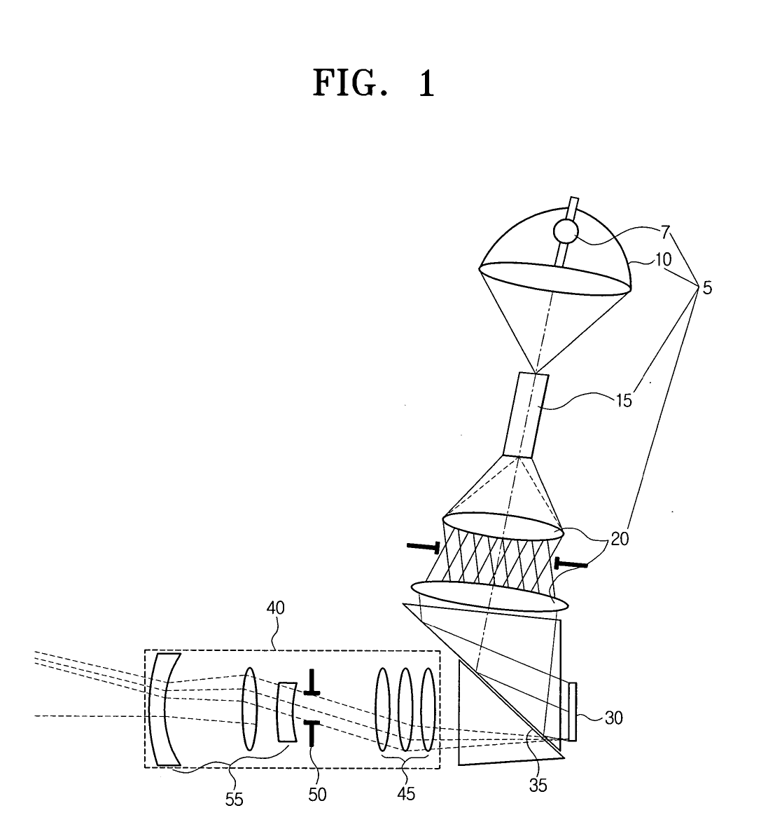

FIG. 1 is a schematic view showing an illuminating block and a projecting block of a projection television (TV). As shown, the illuminating block 5 includes an illuminating lamp 7, an elliptical reflector 10, an optical tunnel 15, a pair of relay lenses 20, and a reflection plate 35. The projecting block 40 includes a front lens group 45, a rear lens group 55, and a projecting aperture 50. A digital micro-mirror device (DMD) 30 is provided between the illuminating block 5 and the projecting block 40.

The illuminating lamp 7 that emits light is set up in the focus of the elliptical reflector 10. The elliptical reflector 10 reflects the light from the illuminating lamp 7 and the light reflected by the elliptical reflector 10 is converged to thereby form a focus.

The optical tunnel 15, in the exemplary embodiment, is formed in the shape of a long hollow rectangular barrel having a rectangular cross section; however, other suitable shapes can be used. The inside of the optical tunnel 15 is formed of a reflection surface for reflecting and outputting the converged light. The reflected rays of light are generated when the light from the illuminating lamp 7 passes through the optical tunnel 15 having a uniform optical intensity in an output end. Therefore, an effect of multiple light sources can be obtained from one illuminating lamp 7.

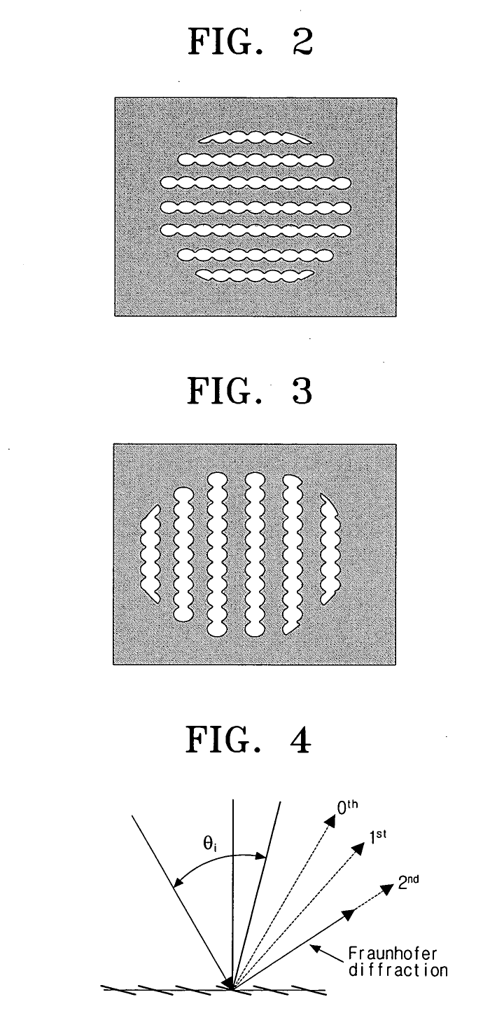

The relay lenses 20 are positioned a predetermined space apart. The relay lenses 20 can channel the rays of light outputted from the optical tunnel 15 into the DMD 30. As illustrated in FIG. 2, the light that passes through the first lens forms a plurality of light convergence points with predetermined vertical and horizontal spacing over a predetermined range.

The reflection plate 35 obliquely reflects the light from the relay lenses 20 and provides the light to the projecting block 40. The reflection plate 35 can be, for example, a reflection mirror or a Total Internal Reflection (TIR) prism.

The DMD 30 is formed of a reflective semiconductor device and a plurality of micro mirrors form a reflection surface of the DMD 30. Each micro mirror is sized about 13 to 16 μm², and the space between micro mirrors is about 17 μm². The micro mirrors confront the pixels of a screen one-to-one. Each micro mirror can be rotated to be set up in a position at an angle of about +10 to +12° or −10 to −12° with respect to the reflection surface of the DMD 30. In the exemplary embodiment, the micro mirrors are set up in a position at about +10 to +12°. The light from the micro mirrors is provided to the projecting block 40 and finally projected onto the screen. Herein, the micro mirrors are in the “on” state. Alternatively, if the micro mirrors are set up in a position at about −10 to −12°, the light from the micro mirrors is reflected to the outside of the projecting block 40 and is not projected onto the screen. Herein, the micro mirrors are in the “off” state.

The projecting block 40 forms an image by receiving and enlarging the light reflected from the DMD 30. The projecting block 40 provides the light to the screen. The projecting block 40 includes a front lens group 45, which includes a plurality of lenses, and a rear lens group 55, which also includes a plurality of lenses. The front lens group 45 converges inhomogeneous luminous flux from the DMD 30. The rear lens group 55 diffuses the luminous flux to reach the screen.

A projection aperture 50 is positioned between the front lens group 45 and the rear lens group 55. The light from the DMD 30 forms a plurality of light convergence points in the position where the projection aperture 50 is placed. The projection aperture 50 removes scattered reflection light and diffracted light from the light having a plurality of light convergence points and provides the light without the scattered reflection light and diffracted light from the front lens group 45 and the rear lens group 55.

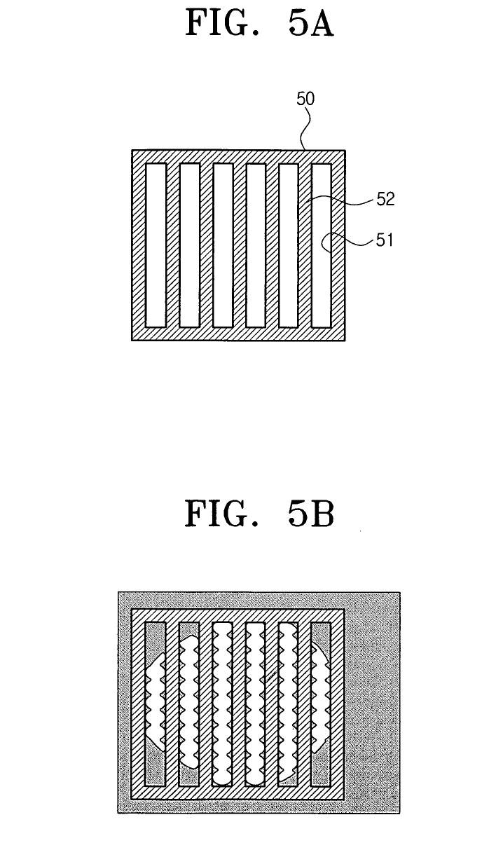

The projection aperture 50, as illustrated in FIGS. 5A and 5B, is formed in the shape of a rectangular frame having a plurality of projection slots 51. The projection slots 51 are arranged along one direction of the frame with a predetermined space between them. The projection slots 51 extend longitudinally. Blocking bars 52 for blocking light are formed between adjacent projection slots 51. The luminous flux that passes through the projection slots 51 of the projection aperture 50 forms rays having predetermined horizontal and vertical spacing. The projection slots 51 are arranged with a predetermined space in the width or transverse direction. Herein, the space between the projection slots 51, that is, the width of a blocking bar 52, is formed to correspond to the space between the light convergence points of the luminous flux that has passed through the front lens group 45.

Therefore, the diffracted light and the scattered reflection light transmitting though the relatively wide space between the light convergence points of the luminous flux are blocked by the blocking bars 52 and only the light from the light convergence points is provided to the rear lens group 55 through the projection slots 51.

The projection aperture 50 can be formed in the shape of a rectangular frame, as illustrated in FIGS. 5A and 5B; however, other suitable arrangements such as circular or elliptical shapes can be used. When the projection aperture 50 is formed in an elliptical shape, it is preferable to arrange the projection aperture 50 so that its longitudinal axis corresponds with the direction in which the luminous flux has the wide space.

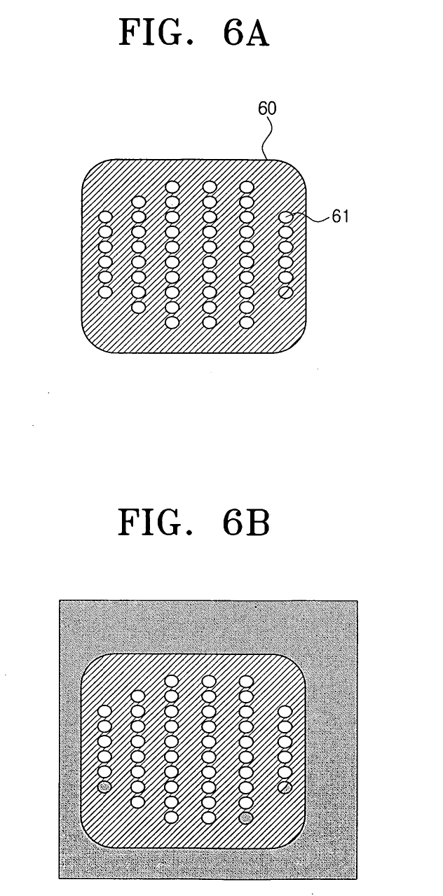

Referring to FIGS. 6A and 6B, a projection aperture 60 has a plurality of penetrating projection openings 61 in positions corresponding to the light convergence points of the luminous flux. The projection aperture 60 can be used when the size of the light convergence points is small and the distance between the light convergence points is larger than a predetermined width. The diffracted light and the scattered reflection light generated in areas other than the light convergence points can be blocked out by forming the multiple projection openings 61 in the entire area of the projection aperture 60 with a predetermined space.

The above-described projection apertures 50 and 60 also perform the conventional function of blocking the diffracted light and the scattered reflection light of the surroundings out of a predetermined range in the luminous flux converged in the front lens group.

The image forming process in the projecting block 40 and the illuminating block 5 of the projection TV will be described hereafter.

When light is emitted from the light source, for example the illuminating lamp 7, the light is reflected in the elliptical reflector 10 to thereby form a focus. The light that forms the focus is provided to the optical tunnel 15 where the light is irregularly reflected and outputted. The outputted light is converged through relay lenses 20. The light forms a plurality of light convergence points between the relay lenses 20. Subsequently, the light enters the DMD 30 through the reflection plate 35. After the light is reflected by the micro mirrors of the DMD 30, the reflected light enters the projecting block 40.

The light inputted into the front lens group 45 is converged through a plurality of lenses and passes through the projection aperture 50 or 60. In the projection aperture 50 or 60, projection slots 51 or projection openings 61 are formed as shown in FIG. 5 or 6. The diffracted light and scattered reflection light of the light that are generated in an area between light convergence points are blocked out in the projection aperture 50 or 60 and the light without the diffracted light and scattered reflection light is inputted into the rear lens group. The inputted light is diffused in the rear lens group 55 and projected onto the screen.

As described above, the exemplary embodiments of the present invention allow only the light from the light convergence points to pass through the projection aperture 50 or 60 by forming a plurality of projection slots 51 or projection openings 61 in the projection aperture 50 or 60, which is placed between the front lens group 45 and the rear lens group 55 of the projecting block 40. Since the exemplary embodiments of the present invention blocks the diffracted light and the scattered reflection light that pass though the space between the light convergence points, it can improve the image clearness of the screen. Particularly, the exemplary embodiments of the present invention can improve the overall image quality by forming a plurality of black and white blocks alternately in the screen and scatter the black and white blocks to thereby increase the contrast of the American National Standards Institute (ANSI).

Although the projection aperture 50 is positioned between the front lens group 45 and the rear lens group 55 in the above-described embodiments, it can be positioned between the relay lenses 20. Even when it is positioned between the relay lenses 20, the same effect obtained by placing the projection aperture 50 between the front lens group 45 and the rear lens group 55 can be achieved. If any of the arrangements of the light convergence points between the front lens group 45 and the rear lens group 55 is formed at about 90° with respect to the arrangement of the light convergence points between the relay lenses 20, the overall size may be different. Therefore, when the projection aperture 50 or 60 is set up between the relay lenses 20, it can be set up in consideration of the size and arrangement direction of the light convergence points that are formed between the relay lenses 20.

As described above, the exemplary embodiments of the present invention can improve the clearness and contrast of image quality by removing the diffracted light and scattered reflection light included in the light source.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A projection television (TV), comprising:
a digital micro-mirror device (DMD) including a plurality of micro mirrors which reflect light from a light source according to an ‘on’ or ‘off’ state of the micro mirrors;
an illuminating block which provides the light to the DMD in a uniform optical intensity by controlling the light from an illuminating lamp as the light source;
a projecting block which projects the light reflected from the DMD onto a screen and
a projection aperture arranged on an optical path of the projecting block on a plane vertical to an optical axis of the optical path; wherein
the projection aperture includes projection areas formed at a predetermined distance from the cross section of the light source which pass light from the light source and blocking areas which block the light.

2. The projection TV of claim 1, wherein the projecting block includes a front lens group which converges the light from the DMD and a rear lens group to diffuse and project the light from the front lens group onto the screen, and the projection aperture is positioned between the front lens group and the rear lens group.

3. The projection TV of claim 2, wherein a plurality of light convergence points are formed between the front lens group and the rear lens group from the light converged by the front lens group in four directions with a predetermined space, and the projection areas of the projection aperture are formed to correspond to the light convergence points.

4. The projection TV of claim 1, wherein the illuminating block includes an optical tunnel which makes the light from the light source have a uniform optical intensity and a plurality of relay lenses which converge the light outputted from the optical tunnel.

5. The projection TV of claim 4, wherein a plurality of light convergence points are formed between the relay lenses from the converged light in all directions with a predetermined space therebetween.

6. The projection TV of claim 1, wherein the projection areas of the projection aperture are arranged in one direction of the projection aperture with a predetermined space, and a plurality of penetrating projection slots are formed longitudinally in the other direction of the projection aperture while the blocking areas are formed in a shape of a long blocking bar in the longitudinal direction of the projection slots and positioned between the projection slots.

7. The projection TV of claim 1, wherein the projection areas corresponding to the light convergence points are formed in a shape of a projection opening penetrating the projection aperture, and the blocking areas are formed to be an area other than the projection openings.

8. A projection television (TV), comprising:
a digital micro-mirror device (DMD) including a plurality of micro mirrors which reflect light from a light source according to an ‘on’ or ‘off’ state of the micro mirrors;
an illuminating block which provides the light to the DMD in a uniform optical intensity by controlling the light from an illuminating lamp as the light source;
a projecting block which projects the light reflected from the DMD onto a screen and
a projection aperture arranged on an optical path of the illuminating block on a plane vertical to an optical axis of the optical path; wherein
the projection aperture includes projection areas formed at a predetermined distance from the cross section of the light source which pass light from the light source and blocking areas which block the light.

9. The projection TV of claim 8, wherein the projecting block includes a front lens group which converges the light from the DMD and a rear lens group to diffuse and project the light from the front lens group onto the screen.

10. The projection TV of claim 9, wherein a plurality of light convergence points are formed between the front lens group and the rear lens group from the light converged by the front lens group in four directions with a predetermined space.

11. The projection TV of claim 8, wherein the illuminating block includes an optical tunnel which makes the light from the light source have a uniform optical intensity and a plurality of relay lenses which converge the light outputted from the optical tunnel; and the projection aperture is placed in any one position between the relay lenses.

12. The projection TV of claim 11, wherein a plurality of light convergence points are formed between the relay lenses from the converged light in all directions with a predetermined space therebetween, and the projection areas of the projection aperture are formed to correspond to the light convergence points between the relay lenses.

13. The projection TV of claim 8, wherein the projection areas of the projection aperture are arranged in one direction of the projection aperture with a predetermined space, and a plurality of penetrating projection slots are formed longitudinally in the other direction of the projection aperture while the blocking areas are formed in a shape of a long blocking bar in the longitudinal direction of the projection slots and positioned between the projection slots.

14. The projection TV of claim 8, wherein the projection areas corresponding to the light convergence points are formed in a shape of a projection opening penetrating the projection aperture, and the blocking areas are formed to be an area except the projection openings.
